(19) United States
(12) Patent Application Publication
(10) Pub. No.: US 2007/0016474 A1
(43) Pub. Date: Jan. 18, 2007

(54) Method, system and computer program product for executing a marketing campaign

(75) Inventors: Pallipuram V. Kannan, Las Gatos, CA (US); Reagan R. Miller, Las Gatos, CA (US)

Correspondence Address: STAINBROOK & STAINBROOK, LLP, 3558 ROUND BARN BLVD., SUITE 203, SANTA ROSA, CA, 95403, US

(73) Assignee: 24/7 CUSTOMER, LOS GATOS, CA (US)

(21) Appl. No.: 11/184,292

(22) Filed: Jul. 18, 2005

(51) Int. Cl. G06Q 30/00

(52) U.S. Cl. 705/14

(57) ABSTRACT

The present invention relates to a method system and a computer program to execute a marketing campaign through multiple communication mediums. Customers are contacted through emails, mails and mails for marketing products or services. The system executing the marketing campaign receives the customers' responses and classifies the customer responses accordingly. The system further generates a consolidated report for the marketing campaign based on the customers' responses.

### BACKGROUND OF THE INVENTION

1. Field of the Invention

The present invention relates to products and services marketing campaigns. More particularly, the invention relates to a method, system and a computer program product for executing a marketing campaign.

2. Description of the Related Art

To grow a business, a company must advertise its products and services. Overtime, companies have come to realize the importance of providing personal attention to their most valued customers. Means used to develop good customer relationships have included personal calls and/or e-mails. These marketing strategies are now referred to as direct marketing techniques. Direct marketing techniques provide a higher customer conversion ratio compared to conventional advertising. The customer conversion ratio is the ratio of customers buying the product to the number of people solicited to buy the same product. Today, many companies are using direct marketing techniques to market their products and services.

One of the most important factors in direct marketing is to identify customers for a particular product or service. In the current scenario, many companies have prepared their own customer databases based on factors such as customer purchase history, potential of a customer, and the like. The companies then market their products and services to such customers.

Various companies advertising their products tend to flood customers with emails or calls. However, the responses of customers are not followed up in a coordinated and integrated manner. Some customers may not require these products, so they would probably unsubscribe to such unwanted emails. Further, tele-marketing agents who market a product through customer calls, in the process come to know about the interests of the customers in the selected product. Sometimes, a customer may ask for more information about the product, either through mail or via calling the toll free number of the company. The customer may also buy the product. However, some of these responses are not updated in the customer database. This kind of inefficiency in updating the customer database may result in breaking of relationship with the customers.

These factors hamper productivity, and waste valuable resources of advertising organizations. On top of that, even a well thought out and organized marketing campaign can suffer unexpected setbacks just because of improper management of customer databases. Moreover, lack of customer database management can result in loss of revenues for the business, as the company may lose its customer base.

In the light of above, there is a need for a system that continuously generates and updates a marketing campaign report with the customer responses to emails, phones, requests for more information, and the like. Further, the system should generate and maintain an integrated report of any product campaign, which includes email and tele-marketing campaigns. Such an integrated customer acquisition report can be used for product marketing campaigns in the future. The method should also help in identifying potential customers based on previous responses.

### SUMMARY OF THE INVENTION

An object of the present invention is to provide a system that generates a consolidated marketing campaign report based on customer responses.

Another object of the present invention is to provide a system that updates the consolidated marketing campaign report based on customer responses.

Yet another object of the present invention is to provide a system which efficiently maintains and updates a customer database.

Yet another object of the present invention is to provide a system to execute a marketing campaign, which ensures that customers who have subscribed to Do Not Solicit (DNS) services are not contacted during the marketing campaign.

Yet another object of the present invention is to provide a system to execute the marketing campaign, which ensures that customers who have carried out a transaction are not contacted again during the marketing campaign. Further, the system ensures that the delivery of products or services is on time.

Still yet another object of the present invention is to automate the aforementioned functions by means of an electronic database into which information regarding all customer information is continuously entered and updated.

In order to attain the above-mentioned objects, the system for executing a marketing campaign contacts a plurality of customers through different mediums of communication such as emails, phone calls and mails, for marketing products or services. Customer requests for information pertaining to the products or services are tracked by the system. Further, transactions carried out by the customers are also tracked. Moreover, customer requests to unsubscribe from the marketing campaign are tracked as well. In the case of electronic or automated communications, system tracking is accomplished automatically with the relevant information integrated real time into the system's electronic database. In the case of non electronic communications, such as phone or post mail, system tracking is accomplished by manually entering relevant information via computer terminal into the same electronic database. Finally, a consolidated report based on the customer responses maintained in the database is generated.

The various embodiments of the present invention provide a method to execute a marketing campaign. Further, the present invention provides a system to execute the marketing campaign and to generate a consolidated report for the marketing campaign. The system avoids the possibility of contacting customers who have bought a product or service or have requested to not be contacted again. In addition, the system records each customer response recorded through any of the communication mediums, for example, emails, phone calls, websites, and mails. Further, the system follows all the customer responses. For example, when the customers carry out a transaction and buy the product or service, the system ensures that the products or services are delivered on time. Alternatively, when the customers ask for additional information, the system ensures that the additional information is provided. The system also ensures that the customers who have requested to unsubscribe are not contacted again by eliminating the customer entries from the contact list being used for the marketing campaign. Moreover, the consolidated report for the marketing campaign can be used for any marketing campaigns executed in the future, and in identifying potential customers based on their responses during the marketing campaign.

### BRIEF DESCRIPTION OF THE DRAWINGS

So that the manner in which the above recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram illustrating an operational environment for various embodiments of the present invention.

FIG. 2 is a flow chart of a method for executing a marketing campaign, in accordance with an embodiment of the present invention.

FIG. 3 is a block diagram illustrating a system for executing a marketing campaign, in accordance with a further embodiment of the present invention.

FIG. 4 is a block diagram illustrating a customer contacting system, in accordance with a further embodiment of the present invention.

FIG. 5 is a block diagram illustrating a customer response interface, in accordance with a further embodiment of the present invention.

FIG. 6 is a block diagram illustrating a customer response tracker, in accordance with a further embodiment of the present invention.

### DETAILED DESCRIPTION

The various embodiments of the present invention provide a method, system and a computer program product for executing a marketing campaign.

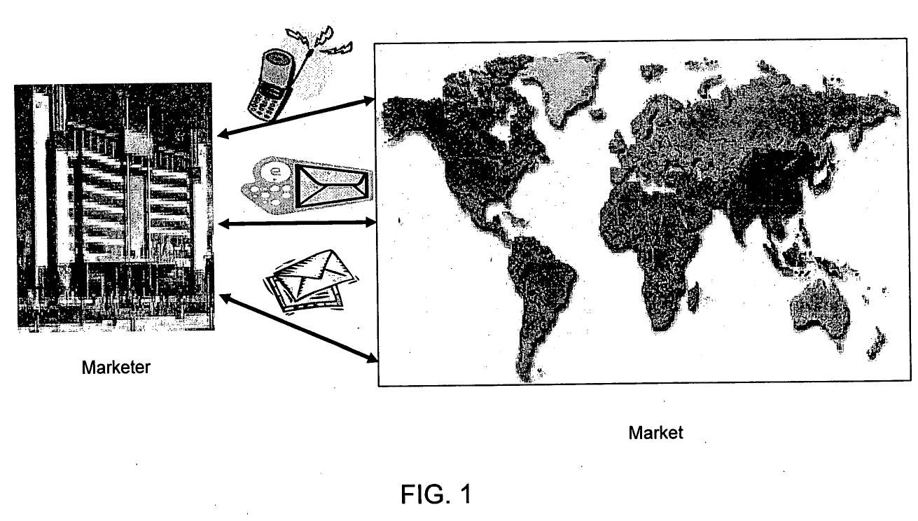

FIG. 1 is a diagram illustrating an operational environment for various embodiments of the present invention. Marketing companies market their products and services by contacting customers in a market by phone calls, emails and mails. These customers can be existing customers or potential customers. The customers may respond by sending mails or by calling a contact number of the marketer. Alternatively, the customers can visit a website of the marketer and register their responses or may send emails to the marketer. In order to execute the marketing campaign successfully, the customer responses need to be tracked.

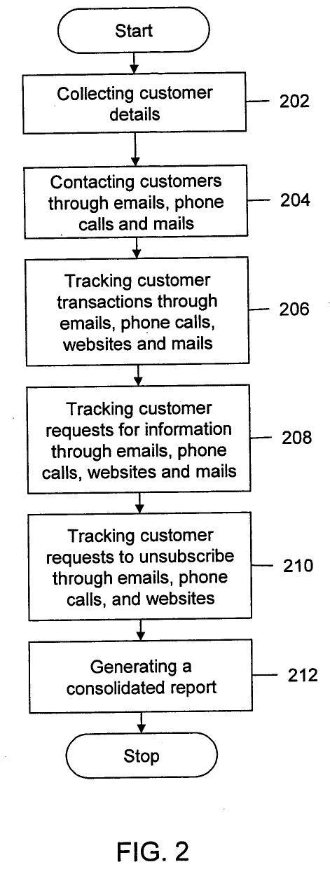

FIG. 2 is a flow chart of a method for executing a marketing campaign, in accordance with an embodiment of the present invention. At step 202, customer details, for example, email addresses, mailing addresses, and contact numbers are collected and incorporated into an electronic database to create a customer contact list. Then at step 204, customers on the contact list are contacted through various communication mediums, such as, phone calls, emails and mails. These contacts can be generated automatically such as by the sending of emails, based on information contained in the database, or by the generation of a telephone call-list for subsequent use based on information in the system database. Customers can respond to the marketer in different ways. The customers may carry out transactions to buy the products or services, the customers may request for information pertaining to the products or services, or the customers may request to unsubscribe from the marketing campaign. The customers' responses need to be tracked i.e. the customers' responses are received and promptly recorded or updated in the database. Therefore, at step 206, transactions carried out by the customers through emails, phone calls, websites, and mails are tracked. At step 208, the customers' requests for information through emails, phone calls, websites, and mails are tracked. Further, at step 210, the customers' requests to unsubscribe through emails, phone calls, and websites are tracked. For tracking responses, customers' responses are first captured, either manually or electronically, and then entered into an electronic database. The electronic database stores marketing campaign details, product and services details, customer details and customer responses. For example, when customers' responses are received through mails, they are entered manually into the electronic database and when the customers' responses are received in an electronic format or through phone calls, the electronic database is accordingly updated. The customers' responses need to be collated to assess success of the marketing campaign and to use the customer responses for future campaigns. Finally, at step 212, a consolidated report comprising the customers' responses is generated automatically.

At step 202, customer details, for example, email addresses, mailing addresses, and contact numbers are collected and entered into the electronic database. The customer details also include spending habits of the customers, preferred method of communication, and the like. The customer details can be obtained from commercially available marketing databases, which provide customer details. The databases can be obtained for free or on a paid basis, such as for example, the databases provided by Hoovers and D&B. The required customer details are extracted by accessing the databases. Alternatively, the marketers can conduct a market survey to collect customer details. The market survey, for example, may include direct meetings with customers, walk-ins for customers, and the like. For those customers who have subscribed to a Do Not Solicit (DNS) service, it should be ensured that such customers are not contacted for the marketing campaign. Therefore, in addition to collecting customer details, details of those customers who have subscribed to DNS service are also gathered. The details of such customers are obtained, for example, by subscribing to national sponsored databases or voluntary databases of individuals who have requested not to be contacted. The customers who have subscribed to DNS services are eliminated from the system's electronic database, and a contact list, which includes the customers who can be contacted for the marketing campaign is generated.

At step 204, customers are contacted through phone calls, emails and mails. During phone calls, information regarding the products or services is provided, as well as purchase details, and contact details of the marketer. In addition, if the customer wants to perform the transaction during the phone call, then the information pertaining to transaction can also be provided. Emails sent to the customers can include information such as details regarding the products or services, contact details of the marketer, and the like. The product or service details may include name of the product or services, market price of the product or service, offer price of the product or service, advantages of the product or service compared with the existing products and services in the market, campaign code, campaign name, and the like. The contact details of the marketer may include, for example, an email address, a contact number, a toll free phone number, a link to a website of the marketer, a mailing address, and the like. The link to the websites of the marketer may also include a customer ID in order to track the customer response to the email. The customer details may include name of the customer, customer ID, and the like. When the customers are contacted by mails the product or service details and the contact details of the marketer, as explained above in case of the emails, can be provided.

In an embodiment of the present invention, step 204 is performed by initially contacting the customers by telephone. If contact with the customer is not established, an email is sent to the customer. In addition, if the customer wants to be contacted again by email rather than phone, the email address of the customer is obtained during the phone call, the address entered into the electronic database, and an email is sent to the customer. Further, sending an email ensures that the customer is provided with the details of the products or services and facilitates customer response.

The customers may respond to the marketer's communication by any of the communication mediums as mentioned above, for example, emails, phone calls, websites, and mails. The customers' responses are generally categorized into three categories. The customer can purchase the product or service. The customer can ask for additional information pertaining to the product or service before deciding on buying the product. The customer can request to unsubscribe from the marketing campaign.

In case a customer requires the products or services and is satisfied with the marketer's offer, the customer can carry out a transaction to buy the products or services through different modes. For example, the customer can place an order for the product and services and give payment details in an email to the marketer. Alternatively, the customer can carry out the transaction by ordering the product and services and giving payment details by calling the toll free number of the marketer or the contact number of the marketer. The customer can also visit the website of the marketer and carry out the transaction at the website. The customer may instead ask for cash on delivery (COD) option for buying the products or services. This means that the customer pays for the products or services upon receipt. The customer may also send the payment by mail, for example, by cheque, money order, cashier's cheque, and the like. At step 206, transactions carried out by the customers through emails, phone calls, websites, and mails are tracked, i.e. details of the transactions are recorded and the electronic database is updated.

The customers may feel that the information provided is not sufficient to make a decision to buy the product and services. Hence, the customers may ask for additional information about the product and services. The customer can ask for additional information by sending an email to the marketer. Alternatively, the customers may ask for additional information of the product and services during an outbound phone call to the customer or the customer can contact the marketer by phone and ask for additional information. Moreover, the customer can ask for additional information by visiting the website of the marketer and requesting the additional information. The customers can further ask for additional information by sending mail or fax. At step 208, customer requests for information through emails, phone calls, websites, and mails are tracked. Further, the customer requests are recorded in the electronic database.

In certain cases, the customer may wish to unsubscribe from the marketing campaign due to certain reasons. For example, the customer may already own the products or services. Alternatively, the customer may not need the product or service. The customer, in such cases, would respond to the marketer by requesting to unsubscribe from the contact list of the marketing campaign. The customers can register the response during the outbound phone call from the marketer or the customers may contact the marketer by phone and request to unsubscribe. The customers may also follow the web link in the email sent by the marketer to register the response to unsubscribe or can visit the website of the marketer for requesting to unsubscribe. Further, the customers can also send emails to the marketer for requesting to unsubscribe. Alternatively, the customer can send a mail requesting to unsubscribe from the marketing campaign. At step 210, customer requests to unsubscribe through emails, phone calls, and websites are tracked, i.e. the requests are recorded for further action in the electronic database.

At step 212, a consolidated report comprising the customers' responses is generated. The consolidated report includes details of the marketing campaign such as the product or service details, customer details, customer responses, and the like. The consolidated report is based on the electronic database, which gets updated according to the customers' responses. The product or service details can include name of the product or service, price of the product or service, the deal offered by the marketer, technical specifications of the product or service, advantages of the product or service over the existing products and services in the market, competitor products information, and the like. The customer details can include contact details of the customer, customer ID or customer name, income group in which the customer falls, and the like. The customers' responses may include the communication medium used for contacting the customer such as emails, phone calls or mails. In addition, the responses registered by the customers such as buying the product or service, requesting for additional information or requesting to unsubscribe are also included. Moreover, the consolidated report is electronically updated on a periodic basis, in accordance with the updates in the electronic database based on the customer responses.

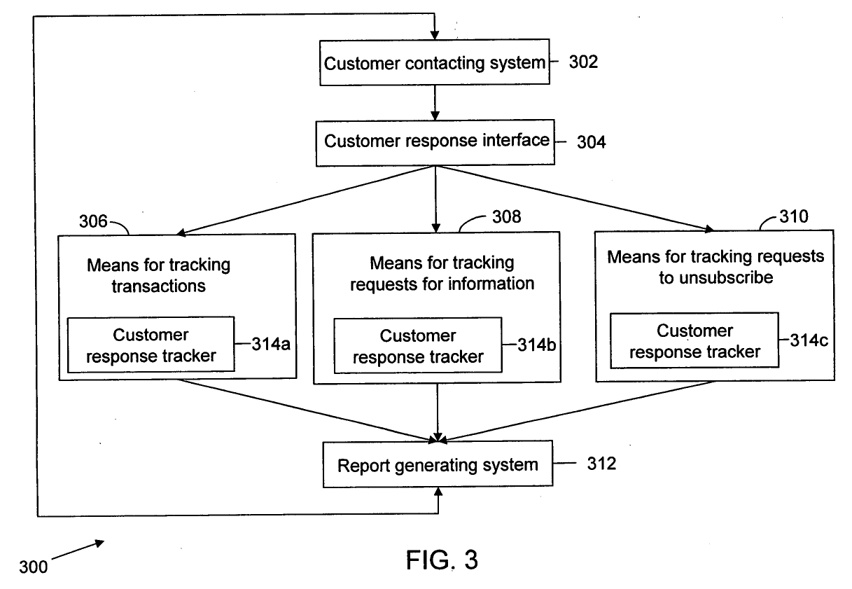

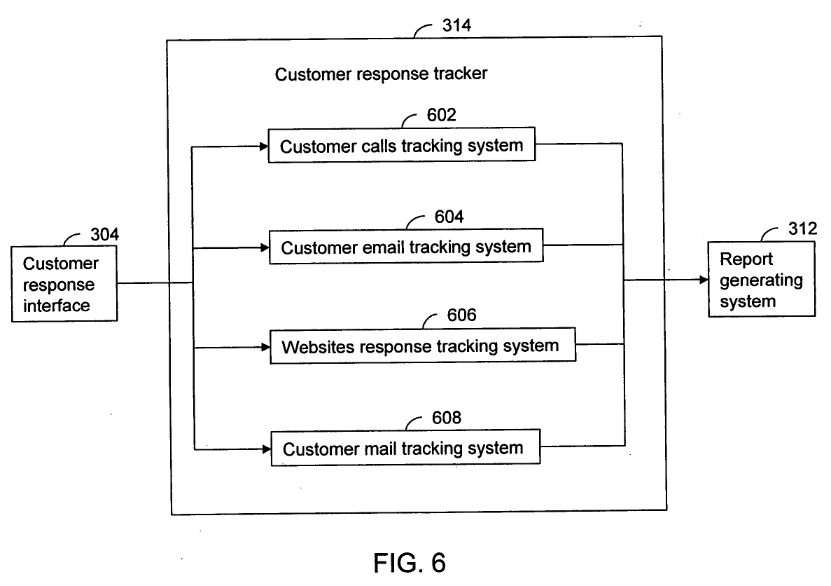

FIG. 3 is a block diagram illustrating a system 300 for executing a marketing campaign, in accordance with an embodiment of the present invention. System 300 comprises a customer contacting system 302, a customer response interface 304, means for tracking transactions 306, means for tracking customer requests for information 308, means for tracking customer requests to unsubscribe 310, and report generating system 312. Customer responses are tracked by customer response vehicles namely means for tracking transactions 306, means for tracking customer requests for information 308, and means for tracking customer requests to unsubscribe 310. Each of these customer response vehicles comprises a customer response tracker 314. Customer response tracker 314 receives customer responses through customer response interface 304 and extracts required information from the customer responses. As shown in FIG. 3, the customer response vehicles 306, 308, and 310 comprise customer response trackers 314a, 314b, and 314c, respectively. Customer response trackers 314a, 314b and 314c are explained later in conjunction with FIG. 6.

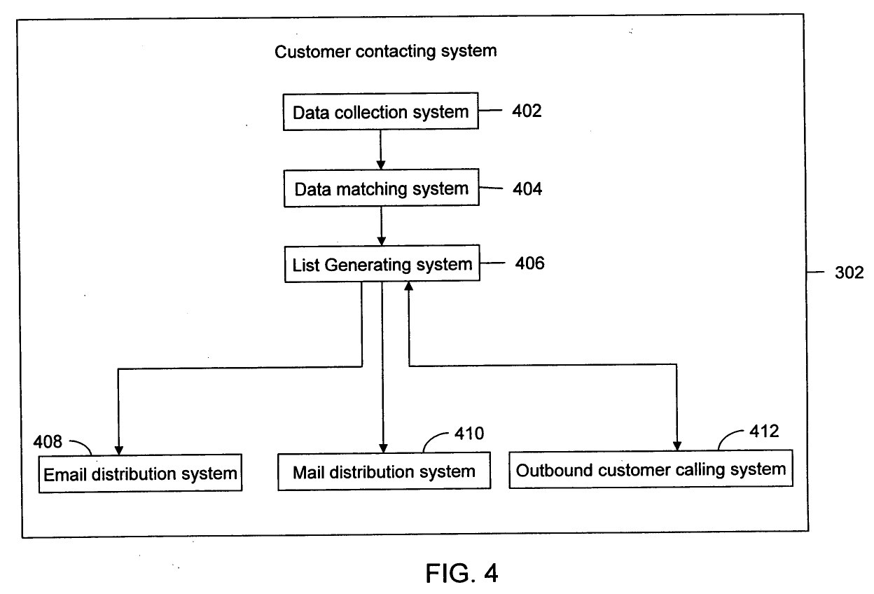

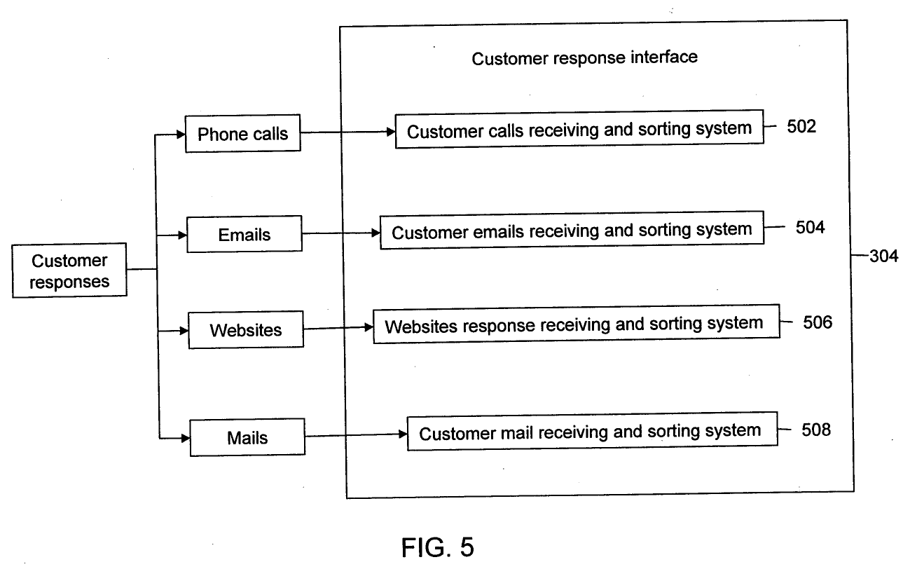

In an embodiment of the present invention, the steps of the method for executing the marketing campaign, as illustrated in FIG. 2, are performed by system 300. Customer contacting system 302 collects the customer details and generates the contact list for the marketing campaign. Further, customer contacting system 302 contacts the customers through phone calls, emails and mails. Customer contacting system 302 is further explained in conjunction with FIG. 4. The customers respond by any of the communication mediums such as emails, phone calls, mails and websites. Then customer response interface 304 receives the customers' responses. Customer response interface 304 also distributes the customer responses to the respective customer response vehicles 306, 308, and 310. Customer response interface 304 is further explained in conjunction with FIG. 5.

Means for tracking transactions 306 tracks the customer transactions carried out through emails, phone calls, websites, and mails. Customer response tracker 314a of means for tracking transactions 306 facilitates tracking of the customer transactions. Further, means for tracking customer requests for information 308 tracks the customer requests through emails, phone calls, websites, and mails for additional information. Customer response tracker 314b of means for tracking customer requests for information 308 tracks the customers' requests for additional information. Further, means for tracking customer requests to unsubscribe 310 tracks the customer requests through emails, phone calls, and websites to unsubscribe. Customer response tracker 314c of means for tracking customer requests to unsubscribe 310 facilitates tracking of the customers' requests to unsubscribe. All of the above mentioned customer response vehicles report the respective customer responses to report generating system 312, which maintains the electronic database and generates the consolidated report based on the electronic database. Customer response trackers 314a, 314b and 314c can be partially manually operated systems, such as in the case of phone calls or mails, or computer programs in the case of electronic communications such as through emails or websites. In a preferred embodiment, customer response trackers 314a, 314b and 314c convert information regarding customer responses to digital form and send this information to report generating system 312, which is a computer program.

Means for tracking transactions 306 collates the customer responses generated through various communication mediums, such as, emails, phone calls, and mails with the help of customer response tracker 314a. Customer response tracker 314a further comprises means for tracking transactions through emails, means for tracking transactions through phone calls, means for tracking transactions through web sites, and means for tracking transactions through mails. Customer response tracker 314a is further explained in conjunction with FIG. 6.

The customer transaction details may comprise, for example, the product details, customer details, payment details, delivery details, and the like. The customer details can be, as explained earlier, customer name, customer ID, and the like. The payment details can be, for example, mode of payment such as by cash, cheque, cashier's cheque, demand draft, credit card, debit card, and the like. The delivery details may include, for example, product delivery date, delivery address, and the like. In an embodiment of the present invention, the customer transaction details are collated and the product or service delivery to the customers is ensured by means for tracking transactions 306. The transaction details of the customer transactions are collated and transferred to report generating system 312 by means for tracking transactions 306. In an embodiment of the present invention, report generating system 312 sends the customer transaction details to customer contacting system 302. Customer contacting system 302 then extracts the customer details from the transaction details and eliminates the customers who have carried out the transaction from the contact list of the marketing campaign. Additionally, means for tracking transactions 306 ensures that the delivery of the product or service is on time, by including the delivery date of the product or service to the customers in the details sent to report generating system 312.

In an embodiment of the present invention, means for tracking transaction 306 is a computer program that tracks the transactions and sends the transaction details to report generating system 312. In another embodiment of the present invention, means for tracking transaction 306 is a system, wherein a group of employees tracks the customer transactions and enter the transaction details manually into the electronic database, in case the customer responses for transactions are through mails. In a preferred embodiment of the present invention, the electronic database is updated with transaction details electronically.

Means for tracking customer requests for information 308 collates the customer responses generated through various communication mediums, such as, emails, phone calls, mails, and web sites with the help of customer response tracker 314b. Details regarding the customer requests for additional information can be, for example, customer details, information requested by the customer, priority of the customer request, and the like. As an example, in case the product being marketed is a credit card, then a customer can ask for information regarding the option of an add-on card, and the pricing for the add-on card. Customer response tracker 314b further comprises means for tracking customer requests for information through emails, means for tracking customer requests for information through phone calls, means for tracking customer requests for information through web sites, and means for tracking customer requests for information through mails. Customer response tracker 314b is further explained in conjunction with FIG. 6.

The details regarding the customer requests for additional information are then transferred to report generating system 312 by means for tracking customer requests for information 308. In an embodiment of the present invention, report generating system 312 transfers the details to customer contacting system 302. Customer contacting system 302 then sends the additional information to the customers through emails or mails. In another embodiment of the present invention, the requested information is extracted by means for tracking customer requests for information 308 from a central database, which stores the information regarding the product or service. Then the details of the customer requests along with the requested information are sent to customer contacting system 302. Customer contacting system 302 then sends the requested information to the customers through emails or mails. In a further embodiment of the present invention, the requested information is manually prepared by a group of employees after the details regarding the customer requests for additional information are sent to report generating system 312.

In an embodiment of the present invention, means for tracking customer requests for information 308 is a computer program that tracks the customer requests for information and sends the request details to report generating system 312. In another embodiment of the present invention, means for tracking customer requests for information 308 is a system, wherein a group of employees tracks the customer requests for information and enter the request details manually into the electronic database, in case the customer requests are through mails. In a preferred embodiment of the present invention, the electronic database is updated with request details electronically.

Means for tracking customer requests to unsubscribe 310 collates the customer responses through the above mentioned communication mediums with the help of customer response tracker 314c. Customer response tracker 314c further comprises means for tracking customer requests to unsubscribe through emails, means for tracking customer requests to unsubscribe through phone calls, means for tracking customer requests to unsubscribe through web sites, and means for tracking customer requests to unsubscribe through mails. Details regarding the customer requests can be, for example, customer details, marketing campaign details, reason for unsubscribe, and the like. Customer response tracker 314c is further explained in conjunction with FIG. 6.

The details regarding the requests to unsubscribe are then sent to report generating system 312. Further, report generating system 312 collates the customer requests to unsubscribe to generate a list of the customers, which is then sent to customer contacting system 302. Customer contacting system 302 further ensures that the customers who have requested to unsubscribe are not contacted again, by eliminating the customers from the contact list for the marketing campaign. In a further embodiment of the present invention, means for tracking customer requests to unsubscribe 310 may prepare a report according to the reasons given by the customers to unsubscribe indicating the percentages of the customers requesting to unsubscribe due to a particular kind of reasons. This report can be utilized to fine-tune the marketing campaign based on the responses of the customers to the marketing campaign.

In an embodiment of the present invention, means for tracking customer requests to unsubscribe 310 is a computer program that tracks the customer requests to unsubscribe and sends the request details to report generating system 312. In another embodiment of the present invention, means for tracking customer requests to unsubscribe 310 is a system, wherein a group of employees tracks the customer requests to unsubscribe and enter the request details manually into the electronic database, in case the customer requests are received through mails. In a preferred embodiment of the present invention, the electronic database is updated with request details electronically.

Report generating system 312 maintains the electronic database and generates the consolidated report of the marketing campaign based on the electronic database. The consolidated report includes details of the marketing campaign such as product details, customer details, customer responses, and the like. The product or service details may include name of the product or service, price of the product or service, deal offered by the marketer, technical specifications of the product or service, advantages of the product or service over the existing products in the market, competitor products information, and the like. The customer details may include contact details of the customer, customer ID or customer name, income group in which the customer falls into, and the like. The customer details are obtained from customer contacting system 302. Customer contacting system 302 provides customer details along with the type of communication medium, for example, emails or phone calls, used to contact the customer. Report generating system 312 receives the customers' responses from means for tracking transactions 306, means for tracking customer requests for information 308, and means for tracking customer requests to unsubscribe 310. Based on the customers' responses, the electronic database is updated. Further, the consolidated report is electronically generated on a periodic basis in accordance with the updates in the electronic database.

In an embodiment of the present invention, report generating system 312 generates a list of customers who have carried out transactions and sends the list to customer contacting system 302 in order to ensure that the customers who have carried out transactions are not contacted again during the marketing campaign for the same product. Report generating system 312 also ensures that the customers who have requested not to be contacted again or have requested to unsubscribe are eliminated from the contact list generated by customer contacting system 302. Moreover, a list of people who have requested for additional information is generated and sent to customer contacting system 302, which further provides the additional information to those who have asked for the same. Additionally, report generating system 312 extracts requested information from the electronic database, which stores relevant information regarding the product or service. Further, the information is sent to customer contacting system 302, to distribute to the customers.

In a further embodiment of the present invention, report generating system 312 generates a report according to the reasons given by the customers to unsubscribe indicating the percentages of the customers requesting to unsubscribe due to same kind of reasons. The report can be then utilized to fine tune the marketing campaign keeping in mind the reasons given by the customers to unsubscribe.

Further, a group of employees can study the report generated by report generating system 312 and manually enter the information requested by the customers and provide the requested information to the customers. Moreover, the reasons to unsubscribe as given in the report generated by report generating system 312 can be studied by a group of employees, who can fine-tune the marketing campaign based on the responses given by the customers. In a preferred embodiment of the present invention, report generating system 312 is a computer program.

FIG. 4 is a block diagram illustrating customer contacting system 302, in accordance with a further embodiment of the present invention. Customer contacting system 302 comprises a data collection system 402, a data matching system 404, a list generating system 406, an email distribution system 408, a mail distribution system 410, and an outbound customer calling system 412.

Customer contacting system 302 comprises data collection system 402 in order to collect required customer details from the available databases that give customer details. Data collection system 402 may comprise data input units, for example, a keyboard connected to a computer, a data extraction system which extracts data from available sources, and the like. Customer contacting system 302 also comprises data matching system 404 in order to eliminate the customers who have subscribed to DNS services or have requested not to be contacted. Data matching system matches the data obtained by data collection system 402 with the database of the people who have subscribed for DNS services. Data matching system 404 eliminates entries that are present in both of the databases and creates a new database that does not contain any customer who has subscribed to DNS services. List generating system 406 generates the contact list, which includes people who are to be contacted for the marketing campaign. After the contact list is generated, customer contacting system 302 contacts the customers by phone calls, emails and mails.

Email distribution system 408 sends emails to the customers comprising product details, customer details, contact details and the like. Further, emails sent to the customers also comprise a link to the website of the marketer, which also includes customer ID in order to track the customer responses if the customer follows the link. In a preferred embodiment of the present invention, email distribution system 408 is a computer program. In an embodiment of the present invention, email distribution system 408 is an automated system, for example, Epiphany—A product of Epiphany Inc.

Mail distribution system 410 sends mail to the customers comprising product details, customer details, contact details, product ordering details, and the like. In an embodiment of the present invention, mail distribution system 410 is a manually operated system. In another embodiment of the present invention, mail distribution system 410 is a combination of a computer program and a manually operated system.

Outbound customer calling system 412 is used to contact customers through phone calls. Outbound customer calling system 412 carries out functions such as to provide the product and services information, to obtain customer details, and to record customer responses during the phone calls to the customers. In a preferred embodiment of the present invention, outbound customer calling system 412 is an automated system, wherein the customer responses are recorded electronically and the customers are answered back using a computer program that makes use of the electronic database. In an embodiment of the present invention, outbound customer calling system 412 is an Interactive Voice Response (IVR) system, wherein customers are given recorded instructions for selecting actions, such as conducting a transaction or requesting for further information. In another embodiment of the present invention, outbound customer calling system 412 is a manually operated system. Customer contacting system 302 contacts the customers and the customers respond to these communications. In case customer contacting system 302 is a manually operated system, operators of customer contacting system 302 enter customer responses using a user interface of a computer. The responses are sent to customer response interface 304.

In an embodiment of the present invention, customer contacting system 302 contacts the customers through the customers' preferred mode of communication. Information regarding the customers' preferred mode of communication is collected by data collection system 402.

FIG. 5 is a block diagram illustrating customer response interface 304, in accordance with a further embodiment of the present invention. Customer response interface 304 comprises a customer calls receiving and sorting system 502, a customer emails receiving and sorting system 504, a websites response receiving and sorting system 506, and a customer mail receiving and sorting system 508. Customer response interface 304 receives the customer responses through phone calls, emails, websites, and mails. Customer response interface 304 along with its components sorts these responses and sends them to respective customer response vehicles.

Customer calls receiving and sorting system 502 receives the customer responses through phone calls and sorts these customer responses. For example, customer calls receiving and sorting system 502 may collect the customer details at the beginning of the phone call. Then customer calls receiving and sorting system 502 will provide the customer with response options such as, “PRESS 1 if you want to carry out transaction”, “PRESS 2 if you would like to request for additional product information”, “PRESS 3 if you would like to request to unsubscribe”, “PRESS 4 for after sales services”, and so forth. Depending on the customer response, customer calls receiving and sorting system 502 connects the customer to the respective customer response vehicle. In a preferred embodiment of the present invention, customer calls receiving and sorting system 502 is an automated system that electronically updates the customer responses. In an embodiment of the present invention, customer calls receiving and sorting system 502 is an IVR system. In another embodiment of the present invention, customer calls receiving and sorting system 502 is a manually operated system, wherein a groups of employees receive customer responses through phone calls and enter the customer responses into the electronic database.

Customer emails receiving and sorting system 504 receives the customer responses through emails. Customer emails receiving and sorting system 504 receives emails and categorizes them into emails requesting for transactions, emails requesting for additional information and emails requesting to unsubscribe. Depending upon the category of the emails, customer emails receiving and sorting system 504 transfers the email to the respective customer response vehicle. In an embodiment of the present invention, customer emails receiving and sorting system 504 is a computer program that does a content-based categorization. For example, email addresses for requesting the transactions, for requesting additional information and that for requesting to unsubscribe can be different and based on the email address the emails can be classified. Alternatively, customer emails receiving and sorting system 504 can be a subject based classification system. A subject based classification system sorts and forwards the emails based on the subject of the email.

Websites response receiving and sorting system 506 receives the customer responses through websites. Websites response receiving and sorting system 506 tracks the customer activities at the websites and depending upon the activities of the customers at the websites classifies the responses. In addition, when the customer follows the link given in the email, the link comprises customer information, hence the customer responses can be tracked. The following are examples of links present that can be provided in the email sent to the customer:

http://companyname.com/product_name/unsub.php?s=customer_name@abc.com&customer_id=25072016

This link helps in tracking customers who want to unsubscribe from the marketing campaign.

http://companyname.com/product_name/add_info.php?s=customer_name@abc.com&customer_id=25072016

This link helps in tracking customers who request for additional information.

http://companyname.com/product_name/buy_online.php?s=customer_name@abc.com &customer_id=25072016

This link helps in tracking customers who wish to conduct a transaction for the product or service.

Here, the link comprises the email address of the customer and a customer identification. Based on the ‘product name’, ‘customer_name’, and ‘customer_id’ the responses are tracked.

Further, depending upon the type of response recorded by the customer at the website, websites response receiving and sorting system 506 transfers the information to the respective customer response vehicle. In an embodiment of the present invention, websites response receiving and sorting system 506 is a computer program. Alternatively, the websites may contain different web pages for the different customer responses, for example, a web page dedicated to conduct transactions, another web page dedicated to request for additional information and so forth. Websites response receiving and sorting system 506 gathers the details from these different web pages and sends them to respective customer response vehicles.

Customer mail receiving and sorting system 508 receives the customer responses through mails. Based on the content of mails, the mails received from customers are categorized as mails related to transactions, mails requesting additional information, and mails requesting to unsubscribe. Further, depending upon the type of response sent by the customer by mail, customer mail receiving and sorting system 508 transfers the information to at least one of a group of means for tracking transactions 306, means for tracking customer requests for information 308, and means for tracking customer requests to unsubscribe 310. In an embodiment of the present invention, customer mail receiving and sorting system 508 is a system, wherein a group of employees enter the customer responses obtained through mails into the electronic database.

Customer response vehicles, such as, means for tracking transactions 306, means for tracking customer requests for information 308, and means for tracking customer requests to unsubscribe 310 get the customer responses from customer response interface 304. The customers register their responses through different communication mediums as explained above. In order to extract the appropriate information from the customer responses, each of the customer response vehicles 306, 308, and 310 comprises customer response trackers 314a, 314b, and 314c respectively. Further, the information to be extracted from emails, mails and websites are different, therefore there is a need for separate means to extract the information from respective responses. Hence, customer response tracker 314a, 314b, and 314c comprise different components, which track the customer responses through different communication mediums, such as emails, mails, and phone calls and collate the customer responses.

FIG. 6 is a block diagram illustrating customer response tracker 314, in accordance with a further embodiment of the present invention. Customer response tracker 314 comprises a customer calls tracking system 602, a customer email tracking system 604, a websites response tracking system 606, and a customer mail tracking system 608. When customer response interface 304 transfers a customer response to one of the customer response vehicles 306, 308, and 310, customer response tracker 314 receives the response. Customer response trackers 314a, 314b, and 314c are instances of customer response tracker 314.

When customer calls receiving and sorting system 502 transfers the phone call to means for tracking transactions 306, customer calls tracking system 602 tracks the customer phone call and extracts the required information regarding the customer transaction such as customer details, payment details, product details and the like.

Further, when an email including details of a transaction is sent by a customer, customer emails receiving and sorting system 504 transfers the email to means for tracking transactions 306. Then, customer email tracking system 604 extracts the required information such as customer details, information requested, product details, and the like from the email.

Alternatively, when the customer carries out a transaction through the website, websites response receiving and sorting system 506 receives the response and transfers to means for tracking transactions 306. Then websites response tracking system 606 extracts information such as, customer details, payment details, delivery details, product details, and the like from the customer response.

In addition, when a mail from the customer is received requesting transaction, customer mail receiving and sorting system 508 transfers the mail to means for tracking transactions 306. Then, customer mail tracking system 608 extracts the required information such as customer details, product details, payment details, and the like from the mail. The information is recorded manually and converted to digital form. This can be done, for example, by an operator entering the required information into a user interface of a computer with the help of a keyboard.

In an embodiment of the present invention, customer response tracker 314 is a computer program. In another embodiment of the present invention, customer response tracker 314 is a system, wherein a group of employees enter the customer responses in the electronic database.

The different components of customer response tracker 314 extract the required information from the customer responses and collate them to generate a database of customer responses. The database of customer responses is electronically updated on a periodic basis and sent to report generating system 312. Report generating system 312 uses the database to generate a consolidated report comprising the details such as customer details, customer responses, and the like. Report generating system 312 also generates various lists of customers, for example, a list of customers who have requested for additional information. Such lists of customers are sent to customer contacting system 302.

Customer contacting system 302 receives the list of customers and then responds to the customers by automatically generating and sending emails, automated phone calls or mails with additional information that the customers have asked for. Additionally, customer contacting system 302 receives the list of people, who have bought the product and services, then customer contacting system 302 first eliminates these customers from the contact list for the marketing campaign and ensures that the product or service is delivered on time. Further, customer contacting system 302 receives the list of people, who have requested to unsubscribe, then customer contacting system 302 eliminates these customers from the contact list for the marketing campaign and ensures that they are not contacted again for the same product.

The various embodiments of the present invention provide a method and system to execute a marketing campaign. Further, the present invention provides a system to maintain an electronic database and generate a consolidated report for the marketing campaign based on the electronic database. The system avoids the possibility of contacting customers who have bought a product or service or have requested to not be contacted again. In addition, the system records each response recorded by the customer through any of the communication mediums, for example, emails, phone calls, websites, and mails, and incorporates the responses into the electronic database. Further, the system follows all the customer responses. For example, when the customers carry out a transaction and buy the product or service, the system ensures that the products or services are delivered on time. Alternatively, when the customers have asked for additional information, the system ensures that the additional information is provided. The system also ensures that the customers who have requested to unsubscribe are not contacted again by eliminating the customer entries from the contact list for the marketing campaign. The customer responses are updated in the electronic database. Moreover, the consolidated report for the marketing campaign can be used for any marketing campaigns executed in the future, and in identifying potential customers based on their responses during the marketing campaign.

The system, as described in the present invention, or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. Microprocessor is connected to a communication bus. Computer also includes a memory. Memory may include Random Access Memory (RAM) and Read Only Memory (ROM). The computer system may further comprise a storage device. It can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The software program containing the set of instructions can be embedded in a computer program product for use with a computer, the computer program product comprising a computer usable medium having a computer readable program code embodied therein. The processing of input data by the processing machine may be in response to user commands, or in response to results of previous processing or in response to a request made by another processing machine.

While the foregoing is directed to embodiments of the present invention, other and further embodiments of the invention may be devised without departing from the basic scope thereof, and the scope thereof is determined by the claims that follow.

1. A computer program product for use with a computer, the computer program product comprising a computer usable medium having a computer readable program code embodied therein for executing a marketing campaign, wherein a plurality of customers are contacted through email and phone calls, the computer program code performing the steps of:
maintaining a database of customer details;
tracking customer requests for information in the database;
collecting customer transaction data in the database;
tracking customer requests to unsubscribe in the database; and
generating a consolidated report based on responses by the customers maintained in the database.

2. The computer program product of claim 1 further comprising a computer program code performing the step of eliminating customers who have subscribed to a Do Not Solicit (DNS) service.

3. The computer program product of claim 1 further comprising a computer program code performing the step of sending emails to the customers.

4. The computer program product of claim 1 wherein the computer program code performing the step of tracking the customer requests for information further comprises computer program code performing the step of tracking the customer requests through one or more of a group consisting of emails, phone calls, web sites, and mails.

5. The computer program product of claim 1 further comprising a computer program code performing the step of sending emails to the customers, wherein the email comprises information.

6. The computer program product of claim 1 wherein the computer program code performing the step of collecting customer transaction data further comprises computer program code performing the step of collecting customer transaction data through one or more of a group consisting of emails, phone calls, and web sites.

7. The computer program product of claim 1 wherein the computer program code performing the step of tracking customer requests to unsubscribe further comprises computer program code performing the step of tracking the customer requests through one or more of a group consisting of emails, phone calls, and web sites.

8. The computer program product of claim 1 wherein the computer program code performing the step of tracking customer requests to unsubscribe further comprises computer program code for eliminating customers who have requested to unsubscribe.

9. The computer program product of claim 1 wherein the computer program code performing the step of generating a consolidated report based on responses by the customers further comprises computer program code for periodically updating the consolidated report.

10. A method for executing a marketing campaign, the method comprising the steps of:
collecting customer information to create a customer contact list;
contacting customers through at least one communication medium selected from a group comprising emails, phone calls and mails;
tracking customer requests for information;
collecting customer transaction data;
tracking customer requests to unsubscribe; and
generating a consolidated report based on responses by the customers, wherein the responses are stored electronically.

11. The method of claim 10 further comprising the step of ensuring that the customers who have subscribed to a Do Not Solicit (DNS) service are not contacted.

12. The method of claim 10 further comprising the step of sending emails to the customers.

13. The method of claim 10 wherein the customer responses for information are tracked through one or more of a group consisting of emails, phone calls, web sites, and mails.

14. The method of claim 10 further comprising the step of responding to a customer request for information.

15. The method of claim 10 wherein the customer transaction data is collected from one or more of a group consisting of emails, phone calls, web sites, and mails.

16. The method of claim 10 wherein the customer requests to unsubscribe are tracked through one or more of a group consisting of emails, phone calls, and web sites.

17. The method of claim 10 further comprising the step of removing customers who have requested to unsubscribe from the customer contact list so that they are not contacted again.

18. The method of claim 10 wherein the step of generating the consolidated report further comprising the step of periodically updating the consolidated report.

19. A system for executing a marketing campaign, wherein a plurality of customers are contacted through email and phone calls, the system comprising:
means for tracking customer requests for information;
means for collecting customer transaction data;
means for tracking customer requests to unsubscribe; and
a report generating system for generating a consolidated report based on responses by the customers.

20. The system of claim 19 further comprising an electronic database, the electronic database storing the responses.

21. The system of claim 19 further comprising a data matching system for eliminating customers who have subscribed to a Do Not Solicit (DNS) service.

22. The system of claim 19 further comprising: an email distribution system for sending emails to the customers.

23. The system of claim 19 further comprising means for sending emails to the customers, wherein the email comprises information.

24. The system of claim 19 wherein the means for tracking customer requests for information comprises at least one of a group consisting of:
means for tracking requests for information through emails;
means for tracking requests for information through phone calls;
means for tracking requests for information through clicks to web sites; and
means for tracking requests for information through mails.

25. The system of claim 19 wherein the means for collecting customer transaction data comprises at least one of a group of consisting of:
means for tracking transactions through emails;
means for tracking transactions through phone calls;
means for tracking transactions through web sites; and
means for tracking transactions through mails.

26. The system of claim 19 wherein the means for tracking customer requests to unsubscribe comprises at least one of a group consisting of:
means for tracking customer requests to unsubscribe through emails;
means for tracking customer requests to unsubscribe through phone calls;
means for tracking customer requests to unsubscribe through web sites; and
means for tracking customer requests to unsubscribe through mails.

27. The system of claim 19 further comprising a data matching system for eliminating customers who have requested to unsubscribe.

28. The system of claim 19 wherein the report generating system comprises means for periodically updating the consolidated report.
